(19) United States
(12) Patent Application Publication
(10) Pub. No.: US 2007/0132923 A1
(43) Pub. Date: Jun. 14, 2007

(54) Systems for displaying images involving transflective thin film transistor liquid crystal displays

(75) Inventors: J.H. Chen, Jhubei City (TW); Hung-Yi Luo, Sanchong City (TW); Cheng-Hsin Chen, Yuanlin Township (TW); Chun-Yi Lee, Jhonghe City (TW); Wei-Hung Chen, Tucheng City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: Toppoly Optoelectronics Corp.

(21) Appl. No.: 11/298,037

(22) Filed: Dec. 9, 2005

(51) Int. Cl. G02F 1/1335

(52) U.S. Cl. 349/114

(57) ABSTRACT

Systems for displaying images and methods of fabricating are provided. A representative system incorporates a transflective thin film transistor liquid crystal display (TFT-LCD) panel having a plurality of subpixels. The display panel comprises a first substrate with a transparent electrodeformed thereon, a reflective electrode on the transparent electrode, a second substrate opposite the first substrate, a liquid crystal layer between the first substrate and the second substrate. The panel also exhibits at least one of: the reflective electrode and the transparent electrode overlap by substantially between 100 and 1000 square micrometers; the reflective electrode and the transparent electrode overlap such that a ratio of an area of overlap of the reflective electrode and the transparent electrode to an area of a corresponding subpixel is substantially between 0.05 and 0.12; and a ratio of an area of the transparent electrode to an area of a corresponding subpixel is substantially between 0.5 and 0.6.

### BACKGROUND

The invention relates to thin film transistor liquid crystal display (TFT-LCD) technology. In conventional fabrication of transflective TFT-LCDs, although the transparent electrode is entirely covered with the reflective electrode, adhesion therebetween can be compromised during subsequent development. In this regard, FIG. 1A is a plan view of a portion of a transflective TFT-LCD panel 1 of a comparative example; and. FIG. 1B is a cross-section taken along A-A′ line of the transflective TFT-LCD panel 1 shown in FIG. 1A.

As shown in FIGS. 1A and 1B, a color filter (CF) substrate 150, a processed TFT array substrate 100 with a TFT structure 102 thereon, and a liquid crystal layer 140 located between the substrates 150 and 100 are provided. A subpixel of the processed TFT array substrate 100 includes a reflective region R and transparent region T. The TFT structure 102 is covered with a planarization layer 104. A transparent electrode 120 of indium tin oxide is conformally formed on the planarization layer 104 and the processed TFT array substrate 100. A reflective electrode 130 is conformally formed on the transparent electrode 120 in the reflective region R bordering transparent region T. Electrochemical reaction between the overlap of reflective electrode 130 and the transparent electrode 120 is induced. Notably, a larger area of overlap between the electrodes 130 and 120 can induce a higher probability of peeling. As a result, problems such as peeling of the reflective electrode occur, significantly affecting overall yield.

### SUMMARY

Systems for displaying images and methods of fabrication are provided. In this regard, an embodiment of such a system comprises a transflective TFT-LCD panel comprising a plurality of subpixels. The panel comprises a first substrate with a transparent electrode thereon, a reflective electrode on the transparent electrode, a second substrate opposite the TFT array substrate, and a liquid crystal layer between the first substrate and the second substrate. In this embodiment, the reflective electrode and the transparent electrode overlap: by substantially between 100 and 1000 square micrometers; or such that a ratio of an area of overlap of the reflective electrode and the transparent electrode to an area of a corresponding subpixel is substantially between 0.05 and 0.12.

Another embodiment of a system for displaying images comprises a transflective thin film transistor liquid crystal display panel having a plurality of subpixels. The panel comprises: a first substrate with a transparent electrode thereon; a reflective electrode on the transparent electrode; a second substrate opposite the first substrate; and a liquid crystal layer between the first substrate and the second substrate. Additionally, the panel exhibits at least one of: the reflective electrode and the transparent electrode overlap by substantially between 100 and 1000 square micrometers; the reflective electrode and the transparent electrode overlap such that a ratio of an area of overlap of the reflective electrode and the transparent electrode to an area of a corresponding subpixel is substantially between 0.05 and 0.12; and a ratio of an area of the transparent electrode to an area of a corresponding subpixel is substantially between 0.5 and 0.6.

An embodiment of a method for fabricating a transflective thin film transistor liquid crystal display panel comprising a plurality of subpixels, comprises: providing a first substrate; forming a transparent electrode, above the first substrate; forming a reflective electrode on the transparent electrode; providing a second substrate opposite the first substrate; and forming a liquid crystal layer between the first substrate and the second substrate; wherein a ratio of an area of the transparent electrode to an area of a corresponding subpixel is substantially between 0.5 and 0.6.

Another embodiment of a method for fabricating a transflective thin film transistor liquid crystal display panel comprising a plurality of subpixels, comprises: providing a first substrate; forming a transparent electrode above the first substrate; forming a reflective electrode on the transparent electrode; providing a second substrate opposite the first substrate; and forming a liquid crystal layer between the first substrate and the second substrate; wherein at least one of: the reflective electrode and the transparent electrode overlap by substantially between 100 and 1000 square micrometers; the reflective electrode and the transparent electrode overlap such that a ratio of an area of overlap of the reflective electrode and the transparent electrode to an area of a corresponding subpixel is substantially between 0.05 and 0.12; and a ratio of an area of the transparent electrode to an area of a corresponding subpixel is substantially between 0.5 and 0.6.

### DESCRIPTION OF THE DRAWINGS

The invention will become more fully understood from the detailed description given hereinbelow and the accompanying drawings, given by way of illustration only and thus not intended to be limitative of the invention.

FIG. 1A is a plan view of a portion of a transflective TFT-LCD panel of a comparative example.

FIG. 1B is a cross-section taken along A-A′ line of the transflective TFT-LCD panel shown in FIG. 1A.

FIG. 2A is a planview of a portion of a transflective TFT-LCD panel of an embodiment of the invention.

FIG. 2B is a cross-section taken along B-B′ line of the transflective TFT-LCD panel shown in FIG. 2A.

FIG. 3 is a schematic diagram of an embodiment of a transflective TFT-LCD device.

FIG. 4 is a schematic diagram of an embodiment of electronic device incorporating the transflective TFT-LCD device shown in FIG. 3.

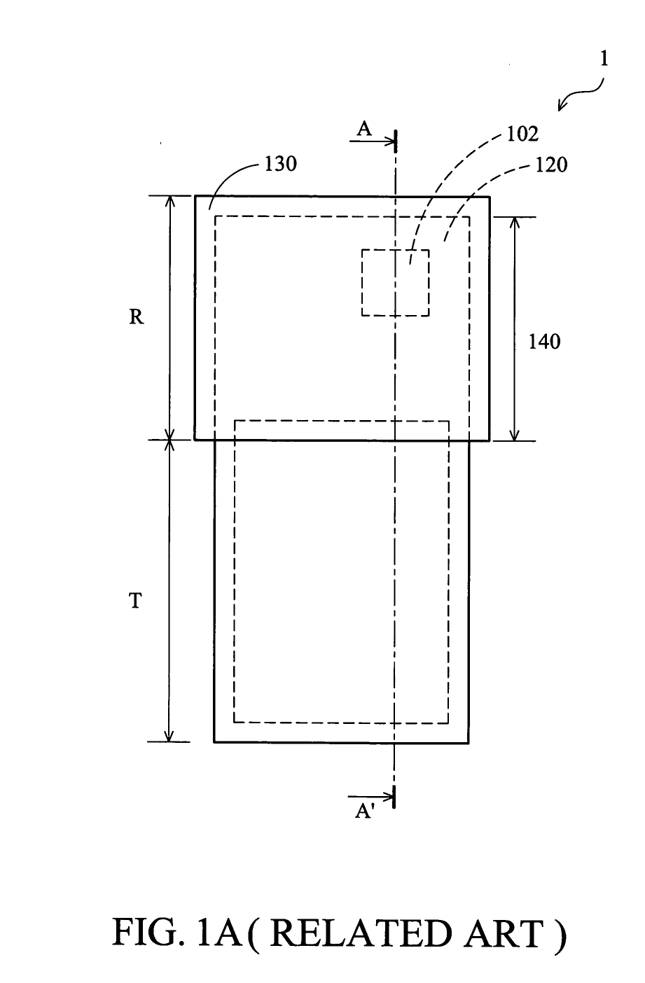

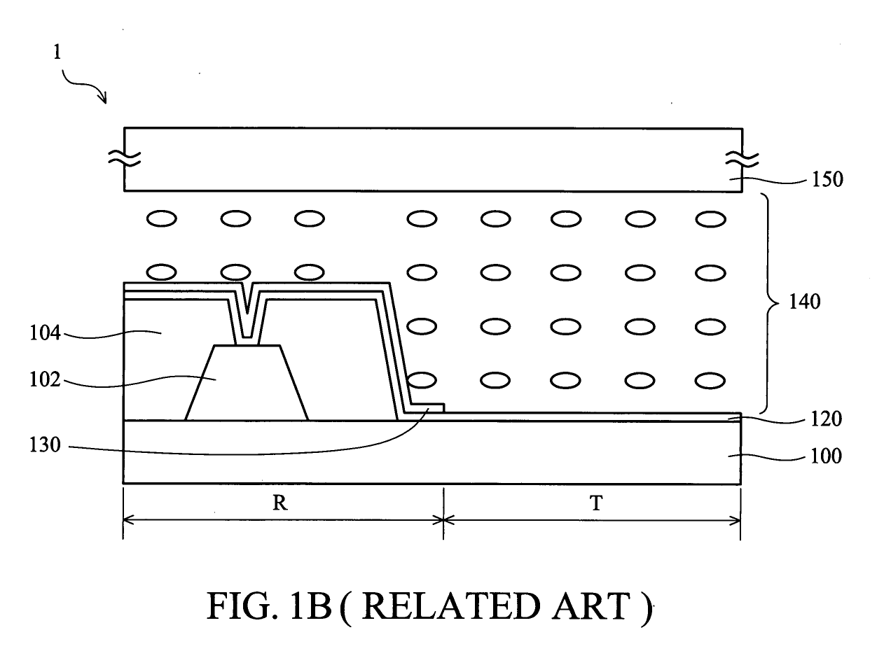

### DETAILED DESCRIPTION

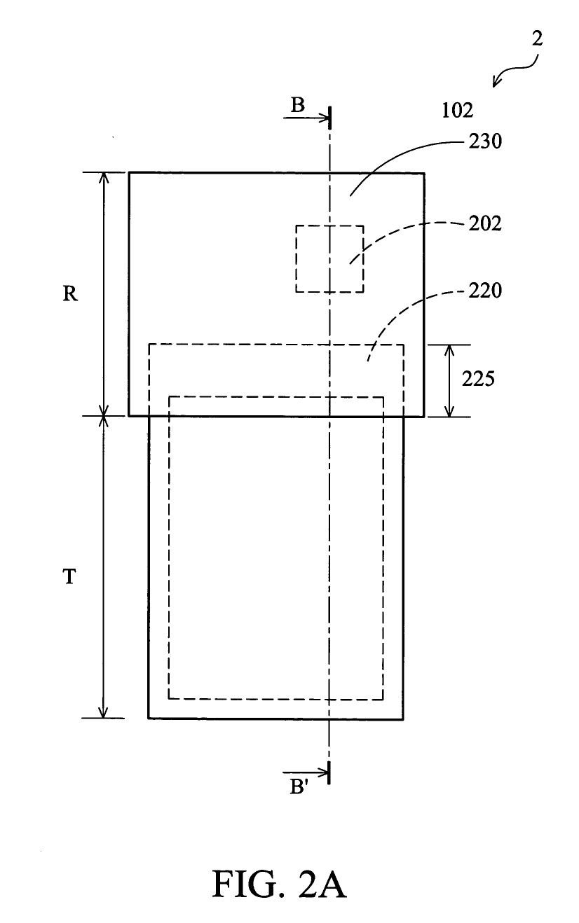

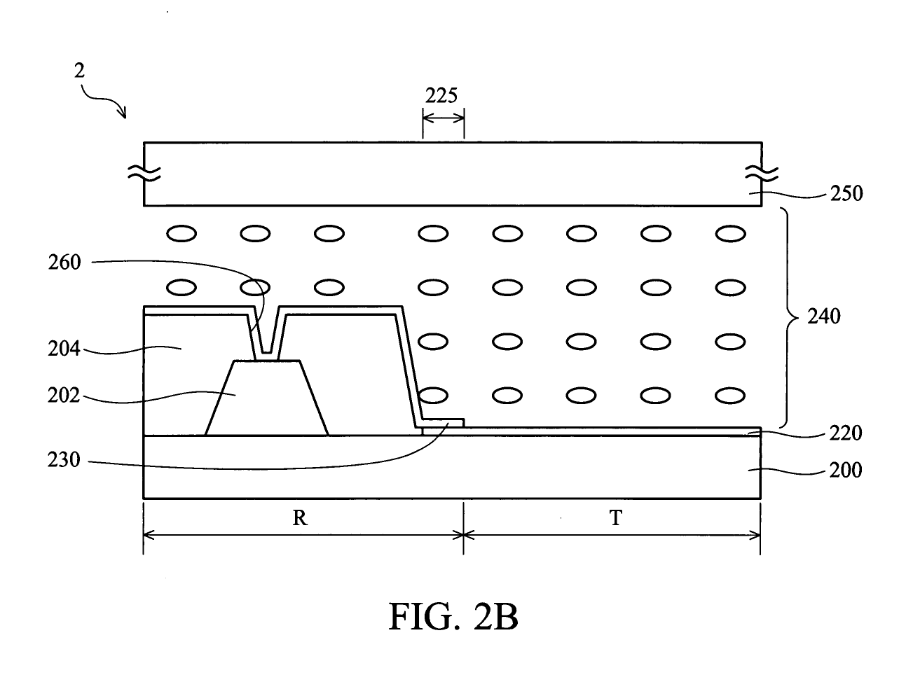

Exemplary embodiments of systems for displaying images and fabrication methods will now be described. In this regard, FIGS. 2A and 2B depict an embodiment of such a system. Specifically, the system incorporates a TFT-LCD panel 2 that includes a second substrate such as CF substrate 250, a processed first substrate such as TFT array substrate 200 with a top-gate type TFT structure 202 formed thereon, and a liquid crystal layer 240 disposed between the substrates 250 and 200. A subpixel of the processed TFT array substrate 200 includes a reflective region R and transparent region T. The TFT structure 202 is covered with a planarization layer 204. A via hole 260 is formed through the planarization layer 204 and portions of the TFT structure 202, exposing the source/drain electrodes (not shown) of the TFT structure 202.

A transparent electrode 220, for example of indium tin oxide, is formed on the processed TFT array substrate 200 beyond planarization layer 204 and the TFT structure 202.

A reflective electrode 230 is conformally formed on the planarization layer 204, lining the via hole 260, thereby electrically connecting to the source/drain electrodes of the TFT structure 202. Accordingly, the transparent electrode 220 electrically connects to the TFT structure 202 via the reflective electrode 230. The reflective electrode 230 comprises aluminum and/or alloys thereof. In other embodiments, the reflective electrode 230 can be formed prior to formation of the transparent electrode 220.

Specifically, overlap 225 between the reflective electrode 230 and the transparent electrode 220 is reduced. As a result, the probability of peeling caused by electrochemical reaction between the reflective electrode 230 and the transparent electrode 220 can be reduced after subsequent development.

Area of the overlap 225 (or overlapping area) depends on product type. For example, the overlap area may range between 100 and 1000 square micrometers, or between 100 and 800 square micrometers, preferably between 150 and 500 square micrometers. In addition, a ratio of the overlapping area to area of each subpixel is between 0.05 and 0.12, preferably between 0.05 and 0.08. Moreover, a ratio of area of the transparent electrode 220 to area of each subpixel is substantially between 0.5 and 0.6.

The transparent electrode 220 comprises indium tin oxide or indium zinc oxide. Materials for other described layers or components are well known.

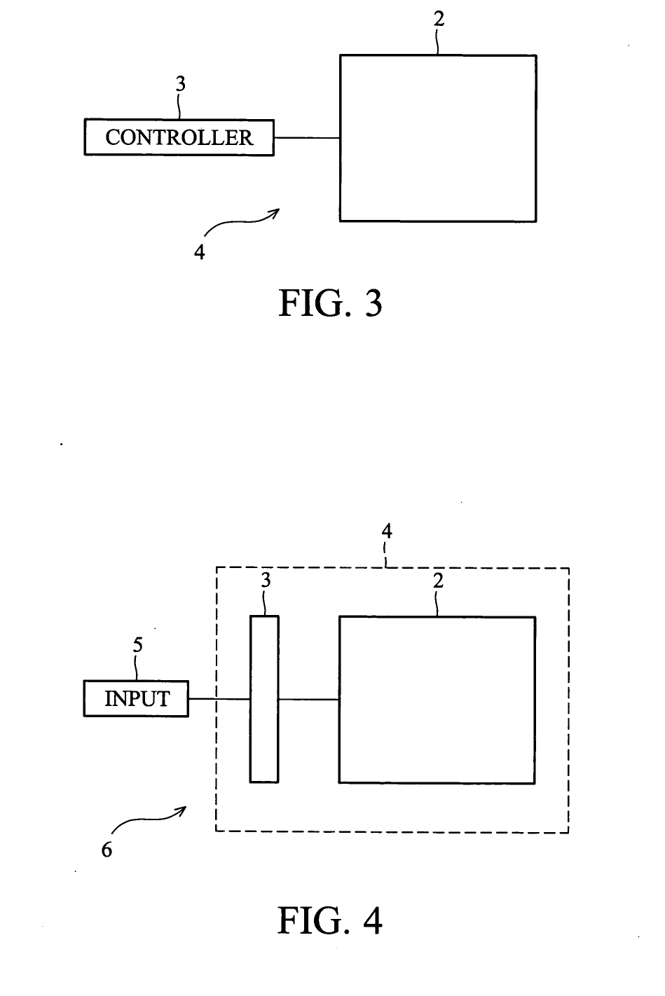

FIG. 3 is a schematic diagram illustrating an embodiment of an LCD device incorporating the transflective TFT-LCD panel 2 of FIG. 2B. The transflective TFT-LCD panel 2 as shown in FIG. 2B is coupled to a controller 3 to form a liquid crystal display device 4. The controller 3 comprises source and gate driving circuits (not shown) to control the LCD panel 2 in accordance with input.

FIG. 4 is a schematic diagram illustrating an embodiment of an electronic device incorporating the TFT-LCD device 4 shown in FIG. 3. An input device 5 is coupled to the controller 3 of the TFT-LCD device 4 shown in FIG. 3 to form an electronic device 6. The input device 5 includes a processor or the like to input data to the controller 3 to, render an image. The electronic device 6 may be a portable device such as a PDA, notebook computer, tablet computer, laptop computer, cellular phone, or a display monitor device, liquid crystal display device, or non-portable device such as a desktop computer.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation to encompass all such modifications and similar arrangements.

What is claimed is:

1. A system for displaying images comprising:
a transflective thin film transistor liquid crystal display panel, comprising:
a first substrate with a transparent electrode thereon;
a reflective electrode disposed on the transparent electrode;
a second substrate opposite the first substrate; and
a liquid crystal layer between the first substrate and the second substrate;
wherein, the reflective electrode and the transparent electrode overlap:
by substantially between 100 and 1000 square micrometers; or
such that a ratio of an area of overlap of the reflective electrode and the transparent electrode to an area of a corresponding subpixel is substantially between 0.05 and 0.12.

2. The system as claimed in claim 1, wherein the transparent electrode comprises indium tin oxide or indium zinc oxide.

3. The system as claimed in claim 2, wherein the overlap is substantially between 100 and 800 square micrometers.

4. The system as claimed in claim 3, wherein the overlap is substantially between 150 and 500 square micrometers.

5. The system as claimed in claim 1, wherein the ratio of the area of the overlap to the area of the corresponding subpixel is substantially between 0.05 and 0.08.

6. A system for displaying images comprising:
a transflective thin film transistor liquid crystal display panel comprising
a plurality of subpixels, the panel comprising:
a first substrate with a transparent electrode thereon;
a reflective electrode on the transparent electrode;
a second substrate opposite the first substrate; and
a liquid crystal layer between the first substrate and the second substrate;
wherein a ratio of area of the transparent electrode to an area of a corresponding subpixel is substantially between 0.5 and 0.6.

7. The system as claimed in claim 6, wherein the transparent electrode comprises indium tin oxide or indium zinc oxide.

8. The system as claimed in claim 1, wherein the system comprises a liquid crystal display device, the liquid crystal display device comprising
the transflective thin film transistor liquid crystal display panel; and the system further comprises:
a controller coupled to the transflective thin film transistor liquid crystal display panel, the controller being operative to control the panel to render images in accordance with input.

9. The system as claimed in claim 8, wherein the system comprises an electronic device comprising the liquid crystal display device.

10. The system as claimed in claim 9, wherein the electronic device is a laptop computer.

11. The system as claimed in claim 1, wherein the system comprises a liquid crystal display device comprising the transparent thin film transistor liquid crystal display panel; and
the system further comprises:
means for controlling the panel to render images.

12. A system for displaying images comprising:
a transflective thin film transistor liquid crystal display panel having a plurality of subpixels, the panel comprising:
a first substrate with a transparent electrode thereon;
a reflective electrode on the transparent electrode;
a second substrate opposite the first substrate; and
a liquid crystal layer between the first substrate and the second substrate;
wherein at least one of:
the reflective electrode and the transparent electrode overlap by substantially between 100 and 1000 square micrometers;
the reflective electrode and the transparent electrode overlap such that a ratio of an area of overlap of the reflective electrode and the transparent electrode to an area of a corresponding subpixel is substantially between 0.05 and 0.12; and
a ratio of an area of the transparent electrode to an area of a corresponding subpixel is substantially between 0.5 and 0.6.
